(19) United States
(12) Patent Application Publication
(10) Pub. No.: US 2017/0211509 A1
(43) Pub. Date: Jul. 27, 2017

(54) Inlet Valve Arrangement and Method for External-Heat Engine

(71) Applicant: Viking Heat Engines AS, Kristiansand (NO)

(72) Inventor: Harald Nes Rislå, Lillesand (NO)

(73) Assignee: Viking Heat Engines AS, Kristiansand (NO)

(21) Appl. No.: 15/452,269

(22) PCT Filed: Sep. 9, 2015
(86) PCT No.: PCT/NO2015/050159

§ 371 Date: Mar. 7, 2017

(30) Foreign Application Priority Data
Sep. 15, 2014 (NO) 20141109

(51) Int. Cl. F02G 1/02; F01L 1/46; F02B 41/06; F01B 17/02; F02B 33/22

(52) U.S. Cl. CPC F02G 1/02; F01B 17/022; F02B 33/22; F02B 41/06; F01L 1/46; F01L 2001/0535

(57) ABSTRACT

An inlet-valve arrangement is for an external-heat engine, which includes at least one working chamber, each one having a cooperating piston. The working chamber is supplied with a working fluid via at least one controlled poppet valve. The poppet valve is arranged to open in the opposite direction to the flow direction of the working fluid. The center axis of the poppet valve is arranged perpendicularly within a deviation of ±45 degrees relative to the center axis of the piston.

### FIELD

This invention relates to an inlet-valve arrangement and a method for an external-heat engine. More particularly, it relates to an inlet-valve arrangement for an external-heat engine, which includes at least one working chamber, each one having a cooperating piston and the working chamber being supplied with a working fluid via at least one controlled poppet valve, the poppet valve being arranged to open in the direction opposite to the flow direction of the fluid. The invention also includes a method for an inlet-valve arrangement for an external-heat engine.

### BACKGROUND

By an external-heat engine is meant, here, an engine in which the working fluid has reached its working pressure prior to entering a working chamber, such as in a motor cylinder, for example by heating outside the external-heat engine, and in which the working fluid is injected into and expands in the external-heat engine.

It is well known to use poppet valves operated by camshafts for both inlet and outlet valves in heat engines. Poppet valves exhibit a relatively high degree of reliability, have long lives and good sealing and also good hydraulic properties such as a relatively low pressure drop during flow-through. The relatively long life and good sealing may be ascribed to, among other things, the fact that, because of the structure of a valve spring, the poppet valve will rotate around its center axis during operation. This rotation also helps to smooth temperature variations in the poppet valve.

There are poppet valves that close against more than one seat, so-called double-seated valves. These have the advantage of low forces being required for them to be opened, even when the pressure difference across the poppet valve is large. The drawback is that they are expensive. Most designs of poppet valves for modern motors close against just one seat. However, poppet valves have a drawback by exhibiting an unreliable closing function if the opening direction coincides with the flow direction through the poppet valve and relatively large pressure differences across the poppet valve are involved. In such cases, extra high spring forces will have to be used to achieve satisfactory closing. These forces would then have to be large enough to resist the pressure difference between the boiler and the cylinder chamber, which will be very unfavourable in most cases.

An obvious solution to this weakness is to let the poppet valve open in the opposite direction to the flow direction, as a differential pressure across the poppet valve will then help to keep the poppet valve closed. A number of such solutions are known, but they are relatively complicated mechanically, with associated unreliable functioning and lifetime, or they contribute to the existence of an unsuitably large dead volume in the working chamber of the external-heat engine. Reasons for this may be that a valve stem and other associated elements, like a valve guide, will take up much space in connection with the working chamber and there will then be an increased dead volume because, conventionally, extra space will be needed for them. In addition, with a valve solution like that, the opening forces will be considerably elevated because of the relatively great pressure difference across the valve.

### SUMMARY

The invention has for its object to remedy or reduce at least one of the drawbacks of the prior art or at least provide a useful alternative to the prior art.

The object is achieved according to the invention through the features that are specified in the description below and in the claims that follow.

According to a first aspect of the invention, an external-heat engine with an inlet-valve arrangement is provided, said external-heat engine including at least one working chamber, each one having a cooperating piston and the working chamber being supplied with a working fluid via at least one controlled poppet valve, the at least one poppet valve being arranged to open in the opposite direction to the flow direction of the fluid, and wherein the center axis of the poppet valve being arranged perpendicularly within a deviation of ±45 degrees relative to the center axis of the piston, characterized in that a valve stem is extending across a dead volume of the working chamber to a rocker arm located on opposite side of the center axis of the piston.

An embodiment according to the invention makes it possible for the valve seat of the at least one poppet valve to be arranged near the piston, whereby a dead volume that is created can be kept within an acceptable size. By a dead volume is meant the volume of the working chamber that cannot be filled by the piston during displacement in normal operation.

If the at least one poppet valve, here the inlet valve, is oriented in the cylinder head with its stem lying diagonally “downwards”, this will require parts of the cylinder head/top to extend below the upper part of the cylinder block, which is impractical in terms of construction.

If the at least one poppet valve is oriented with its stem diagonally “upwards”, the dead volume will increase somewhat, especially at the “top side” of the valve and valve seat, where it is difficult to implement a suitable displacement design, especially in the piston. In consequence, the dead volume will have to be larger then, which is undesirable.

There needs to be only one poppet valve that has this “horizontal” angle.

As indicated above, practical conditions in the arrangement of the valve stem of the at least one poppet valve, a possible valve guide/possible valve guides and the positioning of the valve seat/seats in the cylinder head of the external-heat engine and the size of a dead volume will indicate that a deviation of more than ±45 degrees from the perpendicular position is not relevant.

Owing to the conditions mentioned, it has turned out to be suitable to keep the deviation within ±20 degrees relative to the center axis of the piston, whereas it is the most advantageous for the center axis of the at least one poppet valve to be arranged perpendicularly within a deviation of ±10 degrees relative to the center axis of the piston.

Each working chamber may be supplied with pressurized fluid via more than one poppet valve. The number of poppet valves for the supply of fluid to the working chamber is determined by pressure conditions, required flow area and practical design.

At least two of the poppet valves may be of different sizes. For example, a smaller poppet valve may be arranged to open somewhat before a larger poppet valve to reduce the pressure difference across the larger valve when this is being opened. The aim is to reduce the opening force required and thereby extend the lifetime.

The piston may be formed with a piston head, which projects at least partly into an inlet channel between the at least one poppet valve and the piston when the piston is in its position nearest to the cylinder head, in order thereby to reduce the dead volume.

In the inlet channel, there may be formations arranged to further reduce the dead volume. The formation may typically comprise material, which is arranged over the valve stem/stems and/or the valve guide/guides relative to the piston as is shown in the figures.

The valve guide/guides of the at least one poppet valve may be designed to reduce the volume of the inlet channel.

Both of these features help to increase the efficiency by reducing the dead volume.

One or more of the at least one poppet valve may be controlled by a valve actuator/valve actuators having at least a variable opening profile or a variable opening interval, often termed “variable valve timing”, or, in the simplest case, the opening interval may be displaced relative to the piston position, that is to say relative to the crankshaft position.

The first poppet valve may have a variable opening point and/or variable opening interval, whereas the second poppet valve may have a fixed opening point and/or fixed opening interval.

The invention provides for the valve seat/seats to be arranged relatively close to the piston in relation to the radial direction of the piston.

According to a second aspect of the invention, a method for operating the external-heat engine as disclosed above is provided. The method is characterized by supplying working fluid to the working chamber by opening a second poppet valve before a first poppet valve is opened.

The invention enables the use of a conventional poppet-valve arrangement in an external-heat engine, also when it is necessary to arrange the opening direction of the poppet valve to be counter-current to the flow direction through the poppet valve. The good functional reliability and wear resistance of the conventional poppet-valve arrangement help to make the external-heat engine have the same desired properties as well. In addition, the design of details of the inlet channel, valve guide and piston head helps to increase the efficiency of the external-heat engine.

### BRIEF DESCRIPTION OF THE DRAWINGS

In what follows, an example of a preferred embodiment and method is described, which is visualized in the accompanying drawings, in which:

FIG. 1 shows a section of a piston and part of a cylinder head with an inlet-valve arrangement according to the invention;

FIG. 2 shows the piston and part of the cylinder head in section in another embodiment;

FIG. 3 shows a section II-II of FIG. 2; and

FIG. 4 shows a section IV-IV of FIG. 1.

### DETAILED DESCRIPTION OF THE DRAWINGS

In the drawings, the reference numeral 1 indicates an inlet-valve arrangement located in a cylinder head 2. A piston 4 is shown, but not the rest of the necessary engine components forming part of an external-heat engine 5. These are known to a person skilled in the art.

The inlet-valve arrangement 1 comprises a first poppet valve 6 of a design known per se with a valve head 8 and a valve stem 10, a valve seat 12, a valve guide 14 and a valve spring 16, which is connected to the valve stem 10 by means of a collar 18. The poppet valve 6 has a center axis 20.

A rocker arm 22 is pivotably supported in a supporting piston 24 and arranged to open the poppet valve 6, as a roller 26 in the rocker arm 22 is resting against a camshaft 28. The components 22 to 28 constitute a valve actuator 29.

The supporting piston 24, which is hydraulically operated, is arranged to maintain a desired clearance between the valve stem 10 and the rocker arm 22 when the poppet valve 6 is resting against the valve seat 12.

An inlet channel 30 extends through the cylinder head 2 and join a cylinder not shown above the piston 4. The valve seat 12 is in the inlet channel 30 and, together with the poppet valve 6, defines a dead volume 32 of a working chamber 33.

The dead volume 32 consists of the volume of the working chamber 33 located between the closed poppet valve 6 and the piston 4 when the piston 4 is in its position nearest to the cylinder head 2. The dead volume 32 contributes to a reduction in the compression/expansion ratio, and a larger dead volume 32 thereby reduces the efficiency. The piston 4 has a center axis 34.

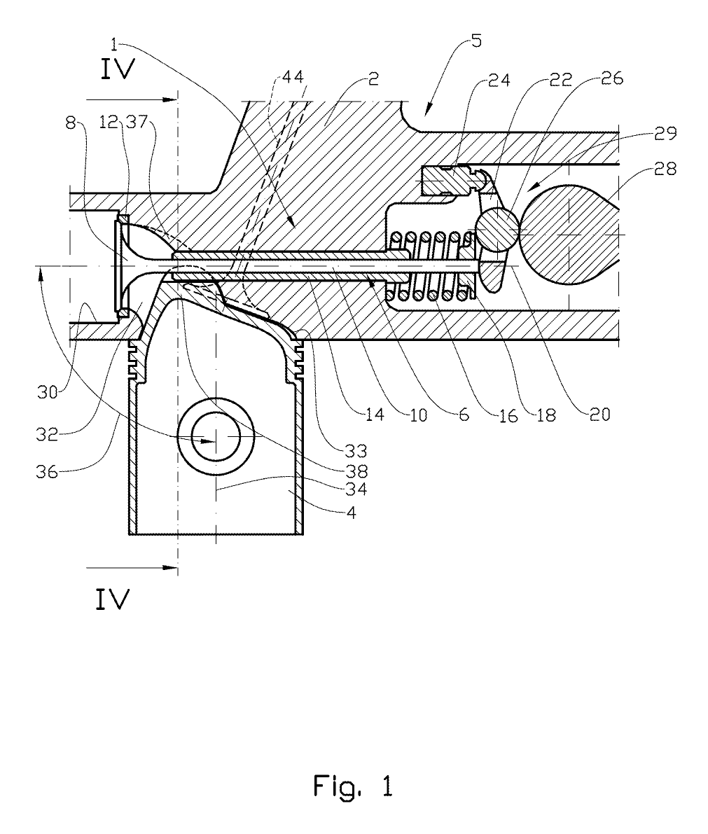

As shown in FIG. 1, the center axis 20 of the poppet valve 6 is practically perpendicular to the center axis 34 of the piston, as indicated by the angle 36. As discussed in the general part of the document, the angle 36 is chosen on the basis of practical conditions with chief emphasis on reducing the dead volume 32.

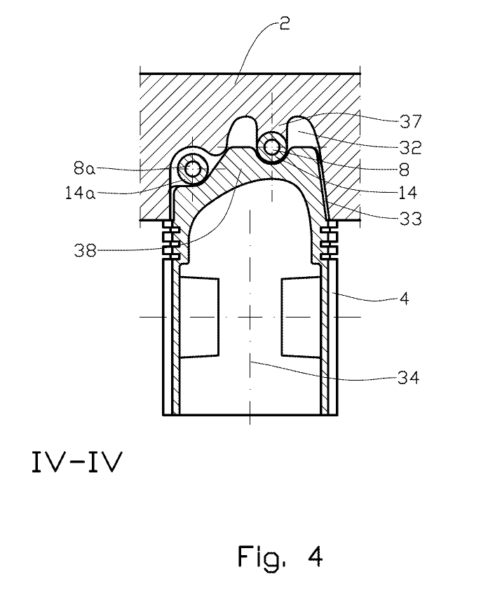

It is sought to reduce the dead volume 32 by other measures as well, such as letting the valve guide 14 project the furthest possible into the dead volume 32, giving the part of the valve guide 14 that is in the dead volume 32 a suitable shape, disposing material 37 in places in the dead volume 32 where it does not obstruct the flow of working fluid to any degree worth mentioning and providing the piston 4 with a piston head 38, which is designed to reduce the dead volume 32 when the piston 4 is in its position nearest to the cylinder head 2, see FIG. 4 as well.

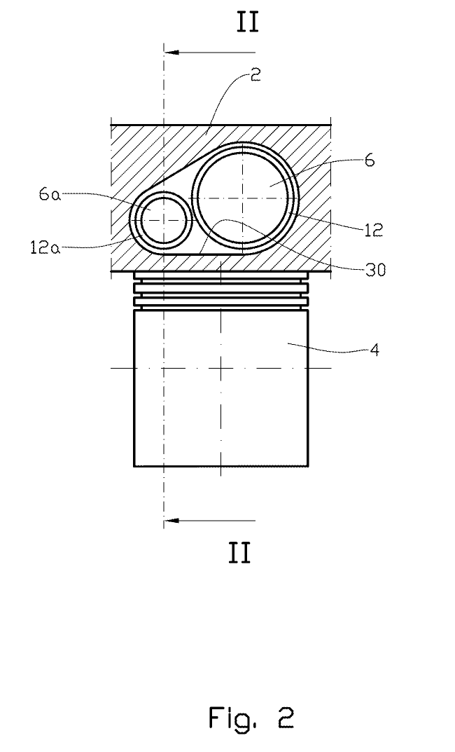

In an alternative embodiment, see FIG. 2, the cylinder head 2 is formed with a second poppet valve 6a, which has a smaller head diameter than the first poppet valve 6. The second poppet valve 6a closes against a second valve seat 12a of a correspondingly smaller diameter, and is controlled in the same way as the first poppet valve 6 by a rocker arm 22a, the equivalent components being identified by the same reference numerals with addition of the letter “a”.

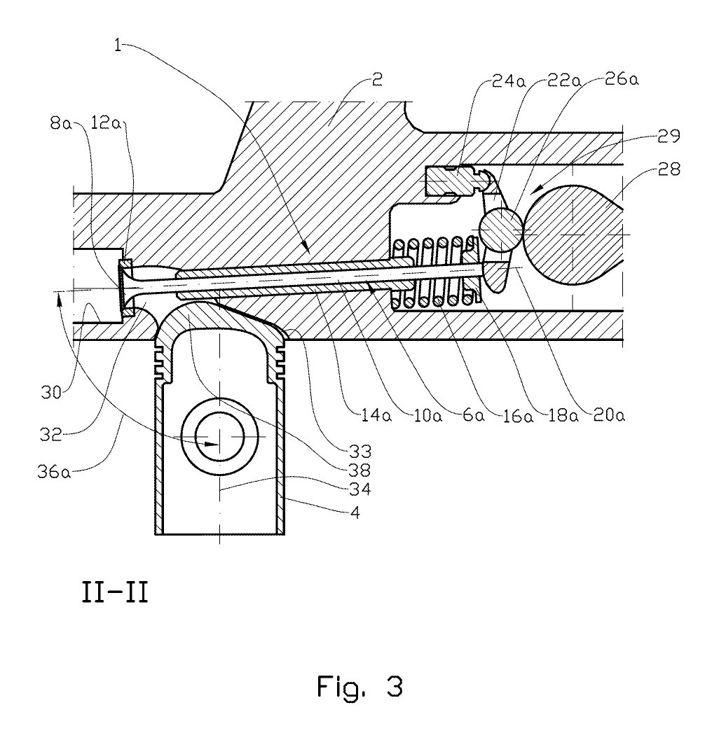

A section II-II in FIG. 3 shows the arrangement of the second poppet valve 6a in the cylinder head 2.

As the pressure difference across the first poppet valve 6 in its closed position may be considerable, the force that has to be applied to the valve stem 10 to open the first poppet valve 6 is relatively large. Such a relatively large force may reduce the life of the rocker arm 22 and adjacent components.

It may therefore be appropriate to let the second poppet valve 6a open somewhat before the first poppet valve 6 to equalize the pressure across the first poppet valve 6 before it is opened, which reduces the required opening force.

A poppet valve in the form of an outlet valve 44 from the working chamber 33 is indicated in FIG. 1. The positioning of the outlet valve 44 relative to the piston 4 may be a conventional one or be formed in some other practical way.

It should be noted that all the above-mentioned embodiments illustrate the invention, but do not limit it, and persons skilled in the art will be able to form many alternative embodiments without departing from the scope of the dependent claims.

In the claims, reference numbers in parentheses are not to be regarded as restrictive.

The use of the verb “to comprise” and its different forms does not exclude the presence of elements or steps, which are not mentioned in the claims. The indefinite article “a” or “an” before an element does not exclude the presence of a plurality of such elements.

1. An inlet-valve arrangement (1) for an external-heat engine (5), which includes at least one working chamber (33), each one having a cooperating piston (4) and the working chamber (33) being supplied with a working fluid via at least one controlled poppet valve (6, 40), the poppet valve (6, 40) being arranged to open in the opposite direction to the flow direction of the working fluid, characterized in that the centre axis (20) of the poppet valve (6, 40) is arranged perpendicularly within a deviation of ±45 degrees relative to the centre axis (34) of the piston (4).

2. The inlet-valve arrangement (1) according to claim 1, characterized in that the centre axis (20) of the poppet valve (6, 40) is arranged perpendicularly within a deviation of ±20 degrees relative to the centre axis (34) of the piston (34).

3. The inlet-valve arrangement (1) according to claim 1, characterized in that the centre axis (20) of the poppet valve (6, 40) is arranged perpendicularly within a deviation of ±10 degrees relative to the centre axis (34) of the piston (34).

4. The inlet-valve arrangement (1) according to claim 1, characterized in that each working chamber (33) is supplied with pressurized fluid via at least two poppet valves (6, 40).

5. The inlet-valve arrangement (1) according to claim 4, characterized in that at least two of the poppet valves (6, 40) are of different sizes.

6. The inlet-valve arrangement (1) according to claim 5, characterized in that a smaller second poppet valve (40) is arranged to open before a larger first poppet valve (6).

7. The inlet-valve arrangement (1) according to claim 1, characterized in that the piston (4) is formed with a piston head (38) which projects at least partly into a dead volume (32) between the poppet valve (6, 40) and the piston (4) when the piston (4) is in its position nearest to the cylinder head (2).

8. The inlet valve arrangement (1) according to claim 1, characterized in that the valve guide (14) of the poppet valve (6, 40) is designed to reduce the volume of the inlet channel (30).

9. A method for an inlet-valve arrangement (1) for an external-heat engine (5) including at least one working chamber (33), each one having a cooperating piston (4) and the working chamber (33) being supplied with a working fluid via at least one controlled poppet valve (6, 40), the poppet valve (6, 40) being arranged to open in the opposite direction to the flow direction of the working fluid, characterized in that the method includes arranging the centre axis of the poppet valve (6, 40) perpendicularly within a deviation of ±45 degrees relative to the centre axis (34) of the piston (4).

10. The method according to claim 9, characterized in that the method includes arranging the centre axis (20) of the poppet valve (6, 40) perpendicularly within a deviation of ±20 degrees relative to the centre axis (34) of the piston (4).

11. The method according to claim 9, characterized in that the method includes arranging the centre axis (20) of the poppet valve (6, 40) perpendicularly within a deviation of ±10 degrees relative to the centre axis (34) of the piston (4).

12. The method according to claim 9, characterized in that the method includes opening a second poppet valve (40) before a first poppet valve (6) when the external-heat engine (5) is operating.
